(19) United States
(12) Patent Application Publication
(10) Pub. No.: US 2025/0172780 A1
(43) Pub. Date: May 29, 2025

(54) FIBER DISTRIBUTION TERMINALS AND OPTICAL COMMUNICATIONS SYSTEMS INCORPORATING THE SAME

(71) Applicant: CORNING RESEARCH & DEVELOPMENT CORPORATION, Corning, NY (US)

(72) Inventors: Shane Blackburn Harmon, Statesville, NC (US); Darin Gregory Howe, Denver, NC (US); Joshua Thomas Smith, Mooresville, NC (US)

(21) Appl. No.: 18/961,574

(22) Filed: Nov. 27, 2024

Related U.S. Application Data
(60) Provisional application No. 63/603,702, filed on Nov. 29, 2023.

(51) Int. Cl. G02B 6/44; G02B 6/38

(52) U.S. Cl. CPC G02B 6/4452; G02B 6/3897; G02B 6/44528

(57) ABSTRACT

In one embodiment, a fiber distribution terminal includes a housing having a body, the housing defining an enclosure, a splitter including an input and a plurality of outputs, an input port on the body of the housing, a plurality of multifiber output ports on the body of the housing, a single fiber optically coupled to the input port and the input of the splitter, and a plurality of multifiber output legs, each multifiber output leg coupled to an individual output of the plurality of outputs of the splitter and to an individual multifiber output port of the plurality of multifiber output ports. If desired, the input port and/or the plurality of multifiber output ports may be on a front face of the housing. Other embodiments of fiber distribution terminals may use a multifiber input port along with a plurality of splitters and a plurality of multifiber output ports.

### RELATED APPLICATIONS

This application claims the benefit of priority of U.S. Provisional Application Ser. No. 63/603,702, filed on Nov. 29, 2023, the content of which is relied upon and incorporated herein by reference in its entirety.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent.

Fiber to the premises (FTTP) is the installation of optical fiber direct to individual buildings such as single-family units, multi-dwelling units, and businesses to provide high-speed broadband access. FTTP dramatically increases connection speeds and reliability for broadband networks compared to legacy copper infrastructure. A current distribution system for providing optical fiber to subscribers is the use of a local convergence point (LCP) enclosure, which is a relatively large cabinet typically located at an entry point of a development. The LCP enclosure receives a feeder cable and includes multiple optical connectors (e.g., SC connectors) and splitters with these fibers distributed to a fiber serving area for making connections to fiber drops to subscribers disposed within. However, these cabinets, which are often designed for more connections than are needed, are large, expensive and not aesthetically pleasing.

Accordingly, alternative fiber distribution components for providing FTTP may be desired.

### SUMMARY

Embodiments of the present disclosure are directed to compact, high-density fiber distribution terminals and optical systems that include these fiber distribution terminals. Embodiments also include methods of testing channels of an optical communication system with minimal interruptions of service to subscribers.

In one embodiment, a fiber distribution terminal includes a housing having a body, the housing defining an enclosure, a splitter including an input and a plurality of outputs, an input port on the body of the housing, a plurality of multifiber output ports on the body of the housing, a single fiber optically coupled to the input port and the input of the splitter, and a plurality of multifiber output legs, each multifiber output leg coupled to an individual output of the plurality of outputs of the splitter and to an individual multifiber output port of the plurality of multifiber output ports.

In another embodiment, an optical communications system includes a fiber distribution terminal that includes a housing having a body, the housing defining an enclosure, a splitter includes an input and a plurality of outputs, an input port on the body of the housing, a plurality of multifiber output ports on the body of the housing, a single fiber optically coupled to the input port and the input of the splitter, and a plurality of multifiber output legs, each multifiber output leg coupled to an individual output of the plurality of outputs of the splitter and to an individual multifiber output port of the plurality of multifiber output ports. The optical communications system also includes an input optical cable assembly having a single optical fiber and a single fiber connector, where the single fiber connector is operable to be coupled to the input port of the terminal. The optical communications system further includes an output optical cable assembly having a plurality of multifiber legs, each multifiber leg being coupled to a multifiber connector operable to be coupled to an individual multifiber output port of the plurality of multifiber output ports. In other variations, the input optical cable assembly could have more than one optical fiber with the additional optical fibers each terminated with a respective single fiber connector, thereby allowing optical connectivity to other fiber distribution terminal(s) or providing spare connectors for future growth or deployments as desired. By way of example, a first optical fiber of the input optical cable assembly is terminated with a single fiber connector that is received in the input port of a first fiber distribution terminal, and a second optical fiber is terminated with a single fiber connector as a spare for later use for optical connection a second fiber distribution terminal. In still other variations, the input fiber connector could be a multi-fiber connector to duplicate the concepts with each respective fiber being in optical communication with a respective input of a splitter, thereby supporting high-fiber counts for the fiber distribution terminals. For instance, fiber distribution terminals may support high-fiber counts such as 256-fibers for the plurality of multifiber output ports. In another embodiment, an optical system includes a fiber distribution terminal that includes a housing having a body, the housing defining an enclosure, a splitter includes an input and a plurality of outputs, an input port on the body of the housing, a plurality of multifiber output ports on the body of the housing, a single fiber optically coupled to the input port and the input of the splitter, and a plurality of multifiber output legs, each multifiber output leg coupled to an individual output of the plurality of outputs of the splitter and to an individual multifiber output port of the plurality of multifiber output ports. The optical system also includes a test optical cable assembly including a multifiber optical cable having a plurality of optical fibers coupled to a multifiber connector at a first end and a plurality of single fiber connectors coupled to a second end of the plurality of optical fibers. The optical system further includes a testing module that includes a test housing defining a test enclosure, a plurality of test single fiber ports at a surface of the test housing operable to receive the plurality of single fiber connectors, a test multifiber port for receiving a multifiber leg of an optical cable assembly, and a plurality of fiber jumpers, where each fiber jumper is optically coupled to the test multifiber port at a first end and an individual test single fiber port of the plurality of test single fiber ports at a second end.

Still other embodiments are directed to fiber distribution terminals comprising a housing having a body with the housing defining an enclosure. The fiber optic terminal comprising a plurality of splitters, a multifiber input port on the housing and having a plurality of input fibers and a plurality of multifiber output ports on the body of the housing. Each of the splitters has an input and a plurality of outputs, and the plurality of splitter comprise a predetermined split ratio. The plurality of multifiber output ports comprise a predetermined fiber count and the predetermined fiber count of the multifiber output ports being different than the predetermined split ratio of the plurality of splitters for the plurality of outputs. A plurality of input fibers each being optically coupled to the multifiber input port and the input of one of the plurality of splitters. A plurality of multifiber output legs with each multifiber output leg coupled to an individual output of the plurality of outputs of one of the plurality of splitters and optically coupled to one of the plurality of multifiber output ports. Fiber distribution terminals may have X-number of splitters and Y-number of multifiber output ports, where the X-number of splitters is different than the Y-number of multifiber output ports. For instance, the fiber distribution terminal may have X-number of splitters that is greater than the Y-number of multifiber output ports. In other variations, the fiber distribution terminal may have X-number of splitters that is less than the Y-number of multifiber output ports. The fiber distribution terminal may also comprise one or more pass-through ports that may be single-fiber ports or multifiber ports.

One fiber distribution terminal may comprise three splitters each having a predetermined split ratio of 1×32 and the plurality of multifiber output ports comprise four multifiber output ports each having the predetermined fiber count of 24-fibers. Another fiber distribution terminal may comprise three splitters each having a predetermined split ratio of 1×32 and the plurality of multifiber output ports comprise eight multifiber output ports each having the predetermined fiber count of 12-fibers.

Fiber distribution terminals may comprise splitters having other predetermined split ratios according to the concepts disclosed. By way of example, the fiber distribution terminal may comprise three splitters each having a predetermined split ratio of 1×16 and the plurality of multifiber output ports comprise two multifiber output ports each having the predetermined fiber count of 24-fibers. Other fiber distribution terminals may comprise three splitters each having a predetermined split ratio of 1×16 and the plurality of multifiber output ports comprise four multifiber output ports each having the predetermined fiber count of 12-fibers.

In another embodiment, a method of testing an optical communication system includes disconnecting a multifiber leg of an optical cable assembly from a multifiber output port of a fiber distribution terminal, the fiber distribution terminal further includes a housing having a body, the housing defining an enclosure, a splitter includes an input and a plurality of outputs, an input port on the body of the housing, a plurality of multifiber output ports on the body of the housing, where the multifiber output port is an individual one of the plurality of multifiber output ports, a single fiber optically coupled to the input port and the input of the splitter, and a plurality of multifiber output legs, each multifiber output leg coupled to an individual output of the plurality of outputs of the splitter and to an individual multifiber output port of the plurality of multifiber output ports. The method also includes connecting the multifiber leg of the optical cable assembly to a test multifiber port of a testing module that includes a test housing defining a test enclosure, a plurality of test single fiber ports at a surface of the test housing, the test multifiber port, and a plurality of fiber jumpers, where each fiber jumper is optically coupled to the test multifiber port at a first end and an individual test single fiber port of the plurality of test single fiber ports at a second end. The method also includes disconnecting a multifiber leg of an optical cable assembly from a multifiber output port of a fiber distribution terminal, the fiber distribution terminal further includes connecting a multifiber connector of a test optical cable assembly to the multifiber output port of the plurality of multifiber output ports and connecting a plurality of single fiber connectors to the plurality of test single fiber ports. The method also includes disconnecting a multifiber leg of an optical cable assembly from a multifiber output port of a fiber distribution terminal, and testing an optical signal propagating within one or more individual single fiber connectors by removing the one or more individual single fiber connectors from the plurality of test single fiber ports.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example fiber distribution terminal according to one or more embodiments described and illustrated herein.

FIG. 2 illustrates an example optical system including an example fiber distribution terminal according to one or more embodiments described and illustrated herein.

FIG. 3 illustrates a perspective view of an example fiber distribution terminal according to one or more embodiments described and illustrated herein.

FIG. 4 illustrates another example fiber distribution terminal having a pass-through fiber and pass-through ports according to one or more embodiments described and illustrated herein.

FIG. 5 illustrates a front view of an example fiber distribution terminal having a plurality of single fiber input ports according to one or more embodiments described and illustrated herein.

FIG. 6 illustrates a front view of another example fiber distribution terminal having a multifiber input port along with four twenty-four fiber output ports and at least one single-fiber pass-thru outport port according to one or more embodiments described and illustrated herein.

FIG. 7 illustrates a schematic wiring scheme for the fiber distribution terminal of FIG. 6 that traverse the splitters showing the multifiber input port having three of the input fibers routed as respective inputs of three 1×32 splitters within the fiber distribution terminal and the output fibers of the three respective 1×32 splitters routed to four 24-fiber multifiber output ports according to one or more embodiments described and illustrated herein.

FIG. 8 illustrates a front view of another example fiber distribution terminal having a multifiber input port along with eight twelve fiber output ports and at least one single-fiber pass-thru output port according to one or more embodiments described and illustrated herein.

FIG. 9 illustrates a schematic wiring scheme for the fiber distribution terminal of FIG. 8 that traverse the splitters showing the multifiber input port having three of the input fibers routed as inputs to three respective 1×32 splitters within the fiber distribution terminal and the output fibers of the three 1×32 splitters routed to eight 12-fiber multifiber output ports according to one or more embodiments described and illustrated herein.

FIG. 10 illustrates a front view of another example fiber distribution terminal having a multifiber input port along with two twenty-four fiber output ports and at least one single-fiber pass-thru output port according to one or more embodiments described and illustrated herein.

FIG. 11 illustrates a schematic wiring scheme for the fiber distribution terminal of FIG. 10 that traverse the splitters showing the multifiber input port having three of the input fibers routed as inputs to three respective 1×16 splitters within the fiber distribution terminal and the output fibers of the three 1×16 splitters routed to two 24-fiber multifiber output ports according to one or more embodiments described and illustrated herein.

FIG. 12 illustrates a front view of another example fiber distribution terminal having a multifiber input port along with four twelve fiber output ports and at least one single-fiber pass-thru output port according to one or more embodiments described and illustrated herein.

FIG. 13 illustrates a schematic wiring scheme for the fiber distribution terminal of FIG. 12 that traverse the splitters showing the multifiber input port having three of the input fibers routed as inputs to three respective 1×16 splitters within the fiber distribution terminal and the output fibers of the three 1×16 splitters routed to four 12-fiber multifiber output ports according to one or more embodiments described and illustrated herein.

FIG. 14 illustrates a front view of an example fiber distribution terminal having single fiber output ports for testing according to one or more embodiments described and illustrated herein.

FIG. 15 illustrates an example optical system including a fiber distribution terminal and a testing module according to one or more embodiments described and illustrated herein.

### DETAILED DESCRIPTION

Embodiments of the present disclosure are directed to compact, high-density fiber distribution terminals for FTTP applications with equivalent number of output fiber connections within hardened components. The small form factor of the fiber distribution terminals described herein as compared to traditional LCP cabinets allow them to be mounted in various locations throughout a network, such as strand, pole, pedestal, wall or handhole mounting. Fiber output configurations can be as high as 256 output fibers per fiber distribution terminal.

The fiber distribution terminals disclosed herein allow rapid deployment through elimination of splice points throughout a fiber serving area with the ability to add additional fiber distribution terminals to the system as the area grows with more subscribers. Adding an additional fiber distribution terminal when the capacity of an initial fiber distribution terminal is fully utilized is still more financially advantageous in some cases compared to purchasing and installing a large cabinet and adding splitters later. This allows for deployment into areas with unplanned growth and could positively impact the business case for the network operator to deploy FTTP into traditionally challenging areas (e.g., low return on investment/long payback sections of homes). Further, the use of hardened pre-terminated optical cables allows for rapid deployment without specialized training or splicing equipment needed.

The fiber distribution terminals described herein provide for simplified material management via fewer SKUs and smaller products, which saves on inventory costs.

Additionally, embodiments provide for the ability to test individual channels of a multifiber connection either by providing breakouts within the fiber distribution terminal itself or by use of a testing module without interrupting other services within the same Multifiber output connection.

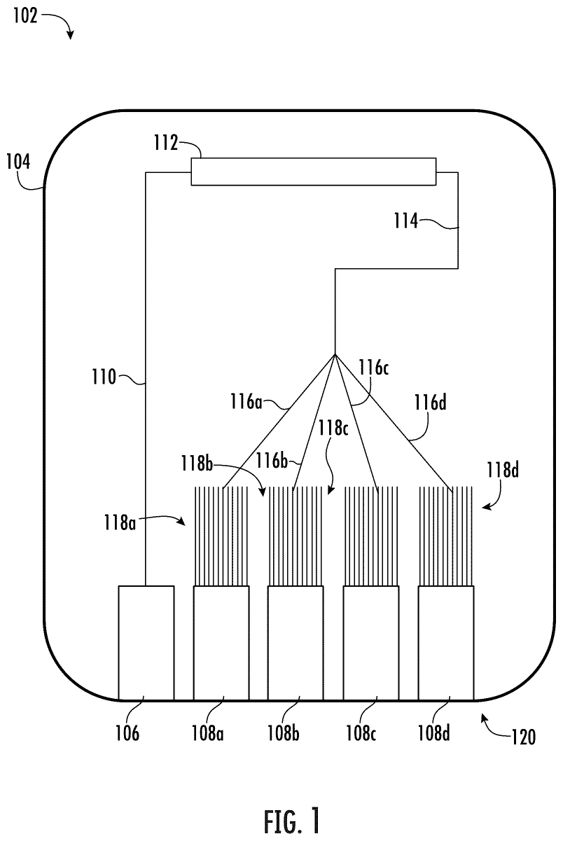

Referring now to FIG. 1, an example fiber distribution terminal 102 is illustrated. The fiber distribution terminal 102 comprises a housing 104 that is ruggedized to withstand exterior environments, such as when the fiber distribution terminal 102 is being secured to a building or a wall, disposed underground in a hand hole, or secured by aerial attachment to an aerial strand or a pole. The housing 104 is much smaller than traditional LCP cabinets, which are large cabinets with optical connectors disposed inside. As non-limiting examples, the dimensions of the fiber distribution fiber distribution terminals 102 may be 15 cm by 8 cm by 3 cm, 15 cm by 13 cm by 3 cm, or 15 cm by 8 cm by 5.8 cm depending on how many output and input ports are utilized. As a further non-limiting example, the fiber distribution terminal 102 may be an Evolv® terminal sold by Corning Optical Communications of Charlotte, North Carolina.

The housing 104 defines an enclosure that surrounds internal components and protects them from the environment. The housing 104 includes a body with a plurality of ports on the body. The plurality of ports of the example fiber distribution terminal 102 includes an input port 106 and a plurality of multifiber output ports 108a-108d. The ports may be disposed at any suitable location on the body of the housing. By way of explanation, and not limitation, the input port may be on the body at a first end and the plurality of multifiber output ports may be on the body at second end. Further, a portion of the ports may be integrally-formed with the body of the housing or not. As illustrated, the input port 106 is disposed on a front face of the body of the housing 104. Likewise, the plurality of multi-fiber output ports 108a-108d are disposed on the front face of the body. Of course, other locations or arrangements of the ports are possible according to the concepts disclosed.

The concepts disclosed could be used with any suitable input port as desired. The input port 106 is operable to receive a single fiber connector (not shown in FIG. 1) of a single fiber leg of a distribution cable or a multi fiber connector of an assembly. As a non-limiting example, the input port 106 may be configured to receive a PushLok™ hardened optical connector sold by Corning Optical Communications. It should be understood that the input port 106 may be configured to accept other types of hardened optical connectors. In the illustrated embodiment, the plurality of multifiber output ports include four multifiber output ports 108a, 108b, 108c, and 108d. The multifiber output ports 108a-108d may be configured to receive multifiber PushLok™ hardened optical connectors. However, the multifiber output ports 108a-108d may be configured to accept other types of hardened optical connectors. More or fewer input ports and multifiber output ports may be provided depending on the application.

Within the enclosure of the housing 104 are an input single fiber 110, a planar waveguide circuit splitter (PLC) splitter 112, and a multifiber bundle 114. The splitter 112 is operable to split an input optical signal into a plurality of output optical signals and/or combine multiple optical signals into one optical signal. Embodiments are not limited by the type of splitter utilized. A PLC splitter, which contains a network of embedded waveguides, may be desirable due to its small size.

One end of the input single fiber 110 is optically coupled to the input port 106 and the other end is optically coupled to an input of the splitter 112. The multifiber bundle 114 is optically coupled to a plurality of outputs of the splitter 112 at a first end. The multifiber bundle 114 has a plurality of multifiber output legs, with each multifiber leg going to an individual multifiber output of the housing 104. In the illustrated embodiment, four multifiber output legs 116a, 116b, 116c, 116d are optically coupled to multifiber output ports 108a, 108b, 108c, 108d by way of fiber fanouts 118a, 118b, 118c, 118d, respectively. Thus, each multifiber output port receives a plurality of optical fibers from the splitter 112. As non-limiting examples, each multifiber output port 108a-108d may receive four, eight, twelve, sixteen, twenty-four or thirty-two optical fibers.

FIG. 1 illustrates a fiber distribution terminal 102 having one single fiber input port feeding a PLC splitter 112 with four separate multifiber output ports in a single row output port terminal. A 12-port or 16-port double-row housing 104 could be used to generate double the number of multifiber output ports by providing two separate splitters being fed by two separate input ports. Alternatively, an 8-port single-row or 4-port double-row body could be used for 8 separate multifiber output ports from a single splitter or multiple splitters.

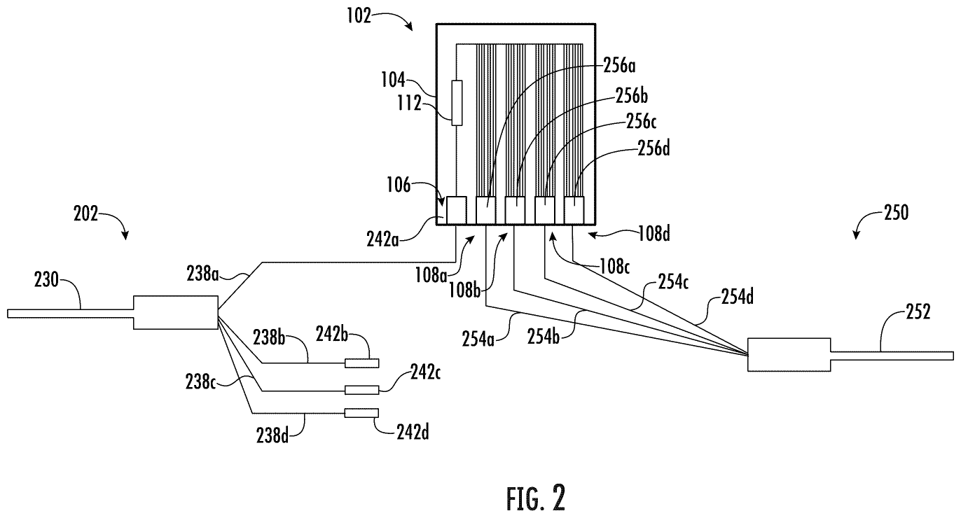

Referring now to FIG. 2, an optical communication system including a fiber distribution terminal 102 is illustrated. The optical communication system also includes an input optical cable assembly 202 and an output optical cable assembly 250. The input optical cable assembly 202 includes a fiber cable 230 that includes a plurality of single fiber legs 238a-238d maintained within an outer jacket. Each single fiber leg 238a-238d includes its own jacket and single optical fiber that is terminated with a single fiber connector 242a-242d. The single fiber connectors 242a-242d are hardened optical connectors operable to be coupled to an input port 106 of the fiber distribution terminal 102. As a non-limiting example, the single fiber connectors 242a-242d may be configured as PushLok™ hardened optical connectors sold by Corning Optical Communications.

Single fiber connector 242a of single fiber leg 238a is mated with the input port 106 of the fiber distribution terminal 102, which couples the single optical fiber of single fiber leg 238a to input single fiber 110. The other single optical fiber legs 238b, 238c, and 238d may be optically coupled to the input ports 106 of other fiber distribution terminals 102, such as downstream fiber distribution terminals 102.

The output optical cable assembly 250 includes a multifiber optical cable 252 that further includes a plurality of multifiber legs 254a-254d maintained within an outer jacket. Each multifiber leg 254a-254d includes its own jacket and set of optical fibers that are terminated by a multifiber connector 256a-256b. As a non-limiting example, the multifiber connectors 256a-256d may be configured as PushLok™ hardened optical connectors sold by Corning Optical Communications. Instead of the plurality of multifiber legs 254a-254d, the output optical cable assembly 250 may comprise one or more a plurality of separate output optical cable assemblies having the respective multifiber connectors terminated on the individual cable assemblies for accomplishing the same optical connectivity for the optical system(s) as desired or not.

As shown in FIG. 2, the multifiber connectors 256a-256d are coupled to the multifiber output ports 108a-108d, respectively, which optically couples the optical fibers of each multifiber leg 254a-254d to the respective multifiber output leg 116a-116d within the fiber distribution terminal 102 and thus the outputs of the splitter 112 (see FIG. 1). Splitters used with fiber distribution terminals disclosed herein may have any suitable predetermined split ratio with outputs defining the split ratio.

An optical signal propagating within single fiber leg 238a toward the fiber distribution terminal 102 is split into a plurality of split optical signals provided to the multifiber output ports 108a-108d (e.g., 32 split optical signals where the splitter 112 is a 1×32 splitter having 32 outputs optically coupled to the four multifiber output ports 108a-108d). These optical signals are then provided to subscribers by way of the output optical cable assembly 250.

Optical signals propagating within the multifiber output legs 116a-116d in a direction from the output optical cable assembly 250 and toward the splitter 112 are combined into a single optical signal by the splitter that is provided to the input single fiber 110 and then to the input optical cable assembly 202 coupled to the input port 106.

It should be understood that any number of input ports and output ports may be provided by the terminal. The various ports may be provided in a single row, or multiple rows, such as two rows.

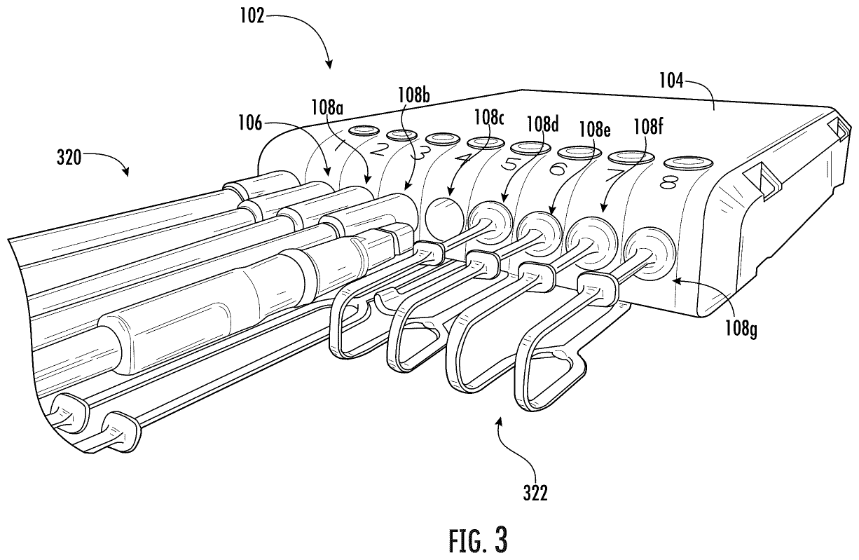

FIG. 3 illustrates an example fiber distribution terminal 102 having one input port 106 and eight output ports 108a-108h, which each output port having a plurality of optical fibers associated therewith. For example, the fiber distribution terminal 102 shown in FIG. 3 may have 64 output optical fibers over the eight output ports 108a-108h. An 128 output fiber distribution terminal may be provided when there are two rows of eight output ports, two input ports, and two splitters, for example.

In cases where not all of the output ports 108a-108h are used, any suitable plugs 322 may be inserted into the unused output ports to ensure environmental sealing for the enclosure of the fiber distribution terminal 102. The unused output ports may be configured so that the passageways are not accessible so that the user will not confuse “live” outport ports with “dead” locations.

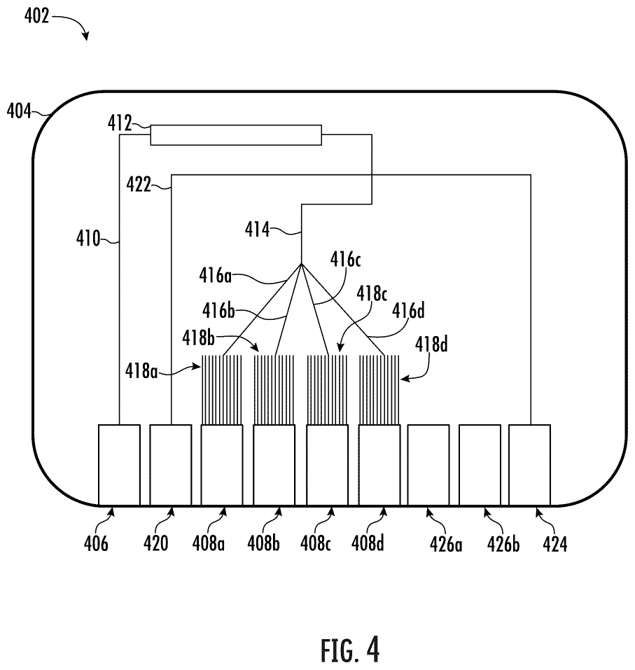

Other configurations are also possible. FIG. 4 schematically illustrates a single row, eight output port fiber distribution terminal 402 similar to the fiber distribution terminal 102 illustrated in FIG. 3. The fiber distribution terminal 402 has a 1×32 splitter 412, and a multifiber bundle 414.

One end of an input single fiber 410 is optically coupled to an input port 406 and the other end is optically coupled to an input of the splitter 412. The multifiber bundle 414 is optically coupled to a plurality of outputs of the splitter 412 at a first end. The multifiber bundle 414 has a plurality of multifiber output legs, with each multifiber leg going to an individual multifiber output of the 404. In the illustrated embodiment, four multifiber output legs 416a, 416b, 416c, and 416d are optically coupled to multifiber output ports 408a, 408b, 408c, and 408d by way of fiber fanouts 418a, 418b, 418c, and 418d, respectively. Thus, each multifiber output port receives a plurality of optical fibers from the splitter 412.

The input port 406 of the fiber distribution terminals may be a single fiber input or a mulitfiber input that feeds multiple splitters as desired using the disclosed concepts. Additionally, select fibers of a multifiber input may be routed to dedicated pass-through ports for fiber distribution terminals disclosed herein. FIGS. 4-13 schematically depict various explanatory examples of these fiber distribution terminals concepts.

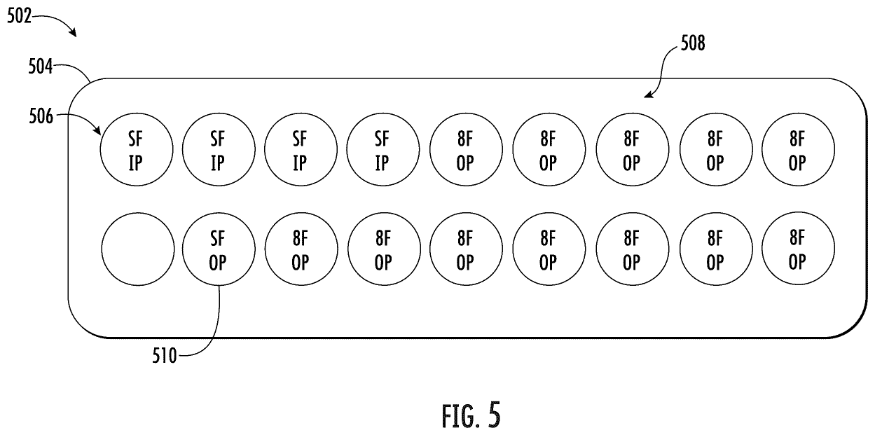

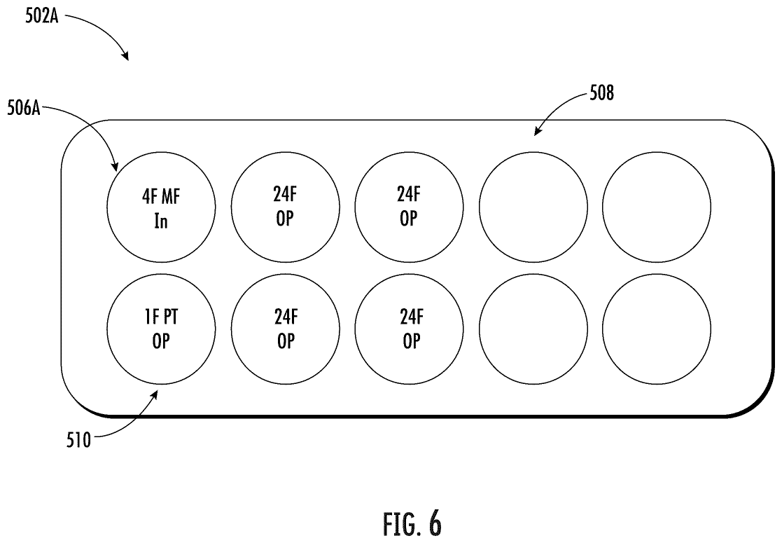

FIGS. 4 and 5 depict the simpler examples with a single fiber input port for the fiber distribution terminal. FIGS. 6-13 depict the explanatory examples of multifiber input ports with X-number of splitters and Y-number of multifiber output ports may vary based on the fiber counts supported by the respective output ports as shown for the explanatory fiber distribution terminals.

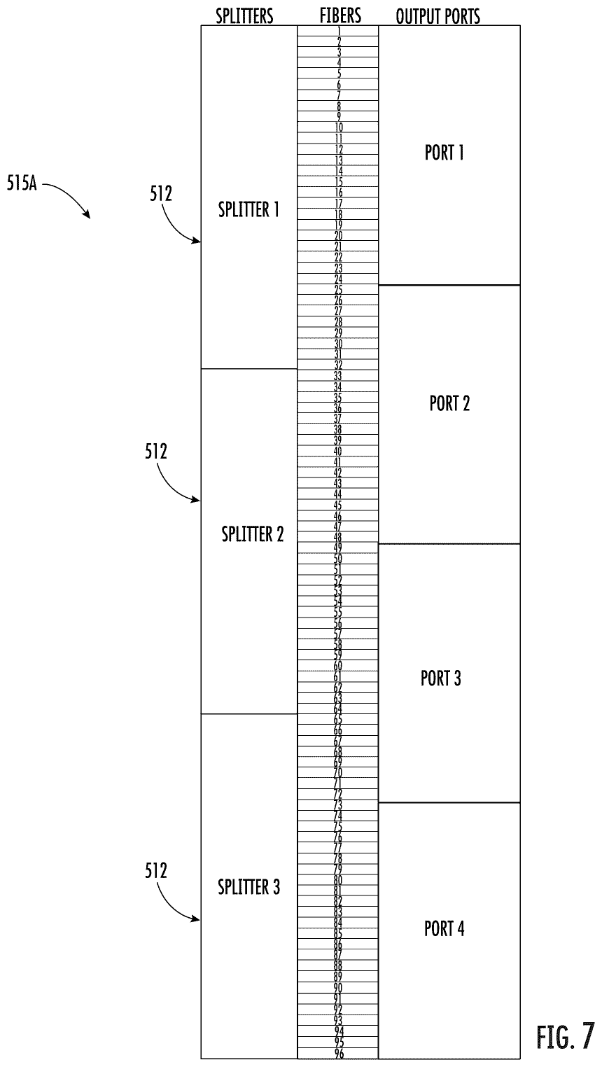

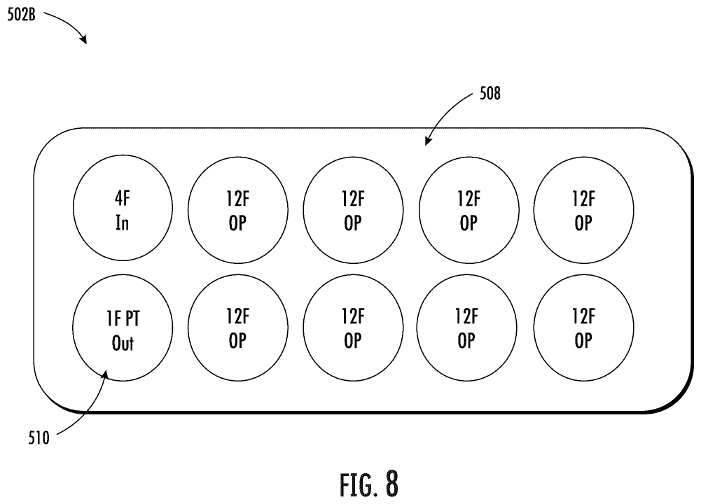

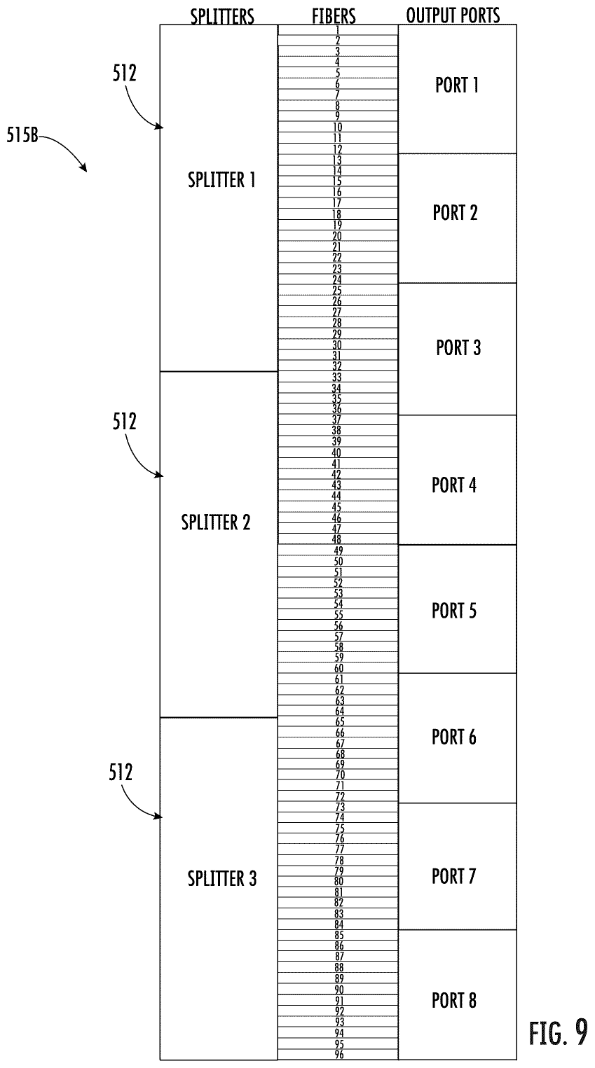

By way of explanation, the fiber distribution terminals may use multiple 1×32 splitters within the fiber distribution terminal, but other split ratios are possible for splitters. Specifically, the fiber distribution terminal 502A of FIGS. 6 and 7 depict an explanatory example of multifiber fiber input ports with three 1×32 splitters and four 24-fiber output ports where two of the 24-fiber output ports include optical fibers from two different 1×32 splitters. The fiber distribution terminal 502B of FIGS. 8 and 9 depict the explanatory examples of multifiber fiber input ports with three 1×32 splitters and eight 12-fiber output ports where two of the 12-fiber output ports include optical fibers from two different 1×32 splitters.

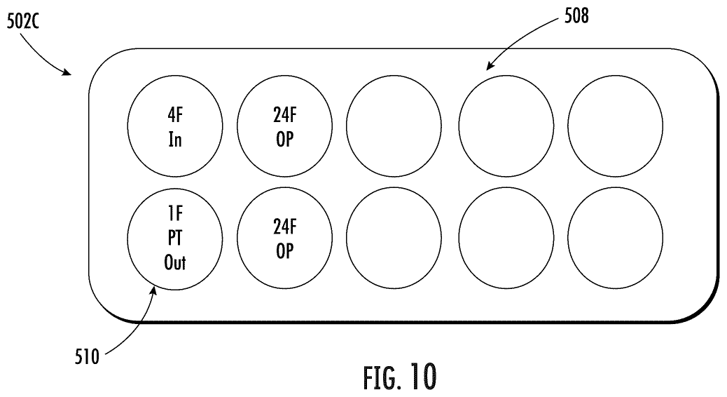

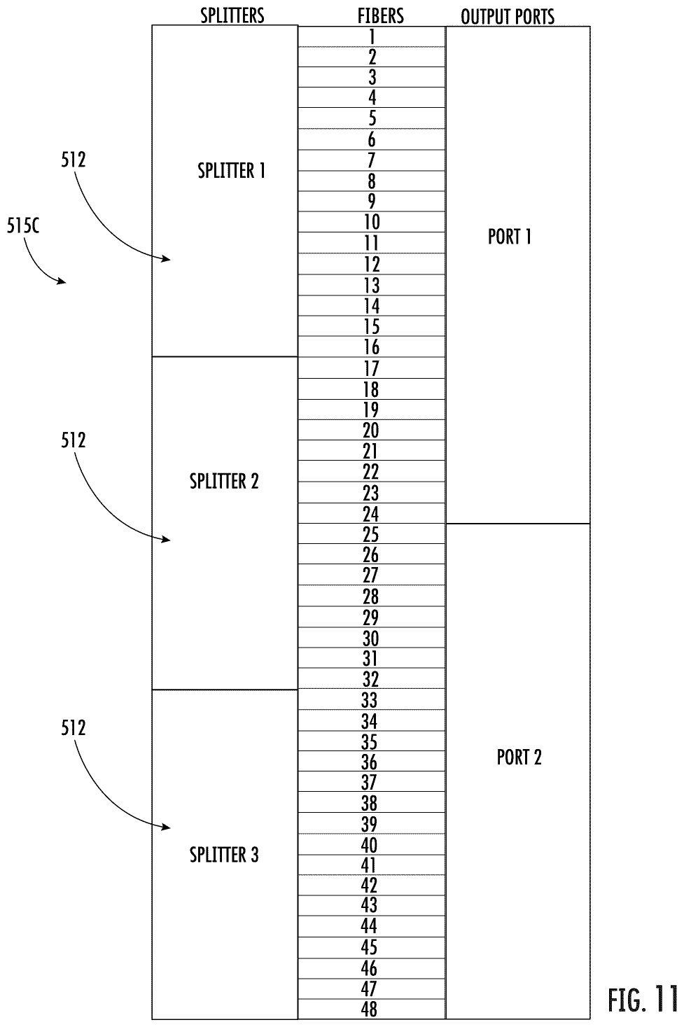

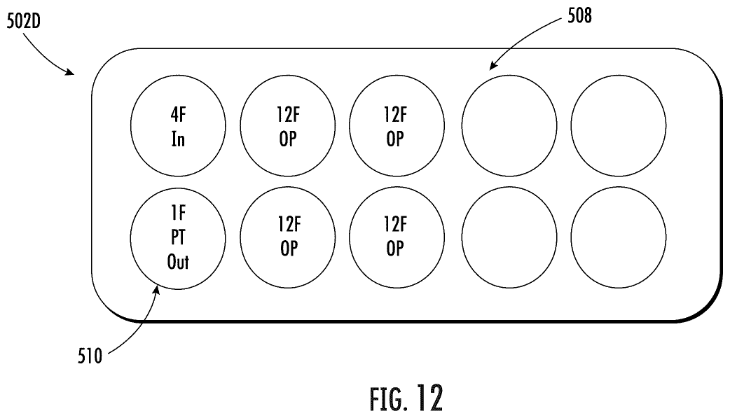

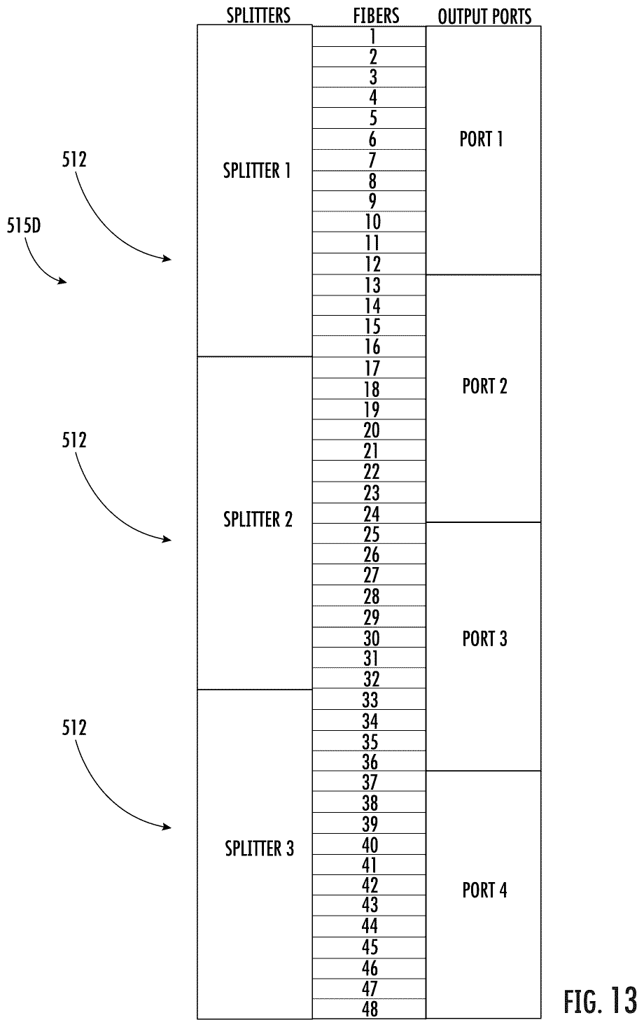

In other variations, the fiber distribution terminals may use multiple 1×16 splitters within the fiber distribution terminal. Specifically, the fiber distribution terminal 502C of FIGS. 10 and 11 depict an explanatory example of multifiber fiber input ports with three 1×16 splitters and two 24-fiber output ports where both of the 24-fiber output ports include optical fibers from two different 1×16 splitters. The fiber distribution terminal 502D of FIGS. 12 and 13 depict the explanatory examples of multifiber fiber input ports with three 1×16 splitters and four 12-fiber output ports where two of the 12-fiber output ports include optical fibers from two different 1×16 splitters.

Of course, other variations of the concepts are possible as well such as using one or more 1×64 splitters within the fiber distribution terminals. For instance, the multifiber fiber input ports may include more than four input fibers. By way of explanation, the multifiber input port may further enabling multiple single fiber pass-through ports or multifiber pass-through ports as desired for a given deployment by using further input fibers such as 6-fiber input port or a 12-fiber input port.

The concepts will first be discussed with fiber distribution terminals having a single-fiber input port. FIG. 4 illustrates a fiber distribution terminal 102 having a pass-through input port 420 in addition to the input port 406 feeding the splitter 412, as well as a single fiber pass-through output port 424. The example fiber distribution terminal 402 also includes a pass-through fiber 422 that is optically coupled to the pass-through input port 420 at a first end and the pass-through output port 424 at a second end. Thus, the pass-through input port 420 and the pass-through output port 424 are optically coupled to one another by way of the pass-through fiber 422. A single fiber connector of an optical cable may be connected to the pass-through output port 424 to daisy-chain two or more fiber distribution terminals 402 together.

In the illustrated embodiment, four outputs are taken up by multifiber output ports 408a, 408b, 408c, and 408d, as well as the pass-through input port 420 and the pass-through output port 424. This leaves empty port 426a and empty port 426b, which may be sealed using plugs 322 as shown in FIG. 3. The unused output ports may be configured so that the passageways are not accessible so that the user will not confuse “live” outport ports with “dead” locations.

Referring now to FIG. 5, a front face of another example fiber distribution terminal 502 is illustrated. Although, the ports are illustrated on the front face for convenience the ports may have any suitable location on the housing. Fiber distribution terminals 502 using the disclosed concepts may use input or output ports having various fiber counts as desired. The use of a terminated cable having one or more input fiber optic connectors as desired for the optical network. By way of explanation, terminated cable that optically connect to the fiber distribution terminals disclosed herein may have one or more single-fiber input connectors or one or more multifiber input connectors for optical connectivity with the fiber distribution terminal as desired.

Likewise, one or more terminated cables for optically connecting to fiber distribution terminals may have one or more single-fiber output connectors or one or more multifiber output connectors for optical connectivity between fiber distribution terminals in the optical network for speedy and efficient deployment in the field.

In the example fiber distribution terminal of FIG. 5, there are two rows of nine ports where there are four single fiber input ports 506 in a top row and twelve multifiber output ports 508 among the top and bottom rows. Three of the single fiber input ports 506 are configured to accept a single fiber connector and are optically coupled to three splitters (not shown). As a non-limiting example, each splitter may be a 1×32 splitter, which yields 96 distribution optical fibers amongst the twelve multifiber output ports 508. Another of the single fiber input ports 506 is used as a pass-through input port that is optically coupled to a single fiber pass-through output port 510 by an internal pass-through optical fiber jumper as described above. Of course, other splitters may be used with the concepts which may change fiber counts for the multifiber output ports 508 such as 1×16 or 1×64 splitters.

Other variations of the fiber distribution terminals may use multifiber input ports 506 instead of using multiple single fiber input ports like fiber distribution terminal 502 of FIG. 5. Examples of these fiber distribution terminal using multifiber input ports will be explained below with reference to FIGS. 6-13 showing fiber distribution terminals 502A-502D using respective wiring schemes 515A-515D, which are similar to the fiber distribution terminal 502 illustrated in FIG. 5. The fiber distribution terminals of FIGS. 6-13 comprise X-number of splitters that is different from the Y-number of multifiber output ports as depicted.

FIG. 6 schematically illustrates another explanatory fiber distribution terminal 502A having a multifiber input port 506a and four multifiber output ports fiber arranged in two rows. Fiber distribution terminal 502A has a multifiber input port 506A having four optical fibers (4F MF) presented at the multifiber input port as shown in FIG. 6. Three of the four input fibers from the multifiber input port 506 each are optically coupled as an input to one of three respective 1×32 splitters, which yields 96 distribution optical fibers amongst the four 24-fiber multifiber output ports (24F OP). The fourth input fiber of fiber input port 506A is routed as a pass-through fiber from the input port 506A to a single fiber pass-through (1F PT) output port 510.

FIG. 7 depicts the partial wiring scheme 515A of the 96 distribution optical fibers from the three 1×32 splitters 512 to four 24-fiber output ports of fiber distribution terminal 502A. As depicted, the first 1×32 splitter (splitter 1) routes optical fibers 1-24 to multifiber port 1 and populates the entirety of the first 24-fiber output port. Splitter 1 also feeds the remaining distribution optical fibers 25-32 to port 2 and partially populates eight channels of the second 24-fiber output port. Splitter 2 feeds distribution optical fibers 33-48 to port 2 for populating the remaining 16 channels of the second 24-fiber output port as shown. Splitter 2 also feeds distribution optical fibers 49-64 to port 3 for populating the first 16 channels of the third 24-fiber output port as shown. Splitter 3 feeds the distribution optical fibers 65-72 to port 3 and partially populates the last eight channels of the third 24-fiber output port. Splitter 3 feeds the distribution optical fibers 73-96 to port 4 and partially populates the last sixteen channels of the four 24-fiber output port. Consequently, two of four 24-fiber output ports (ports 2 and 3) of fiber distribution terminal 502A are fed distribution optical fibers from two of the three splitters in the fiber distribution terminal 502A.

Other variations of the wiring scheme of the 96 distribution optical fibers from the three 1×32 splitters for fiber distribution terminals are also possible by changing the fiber count of the multifiber output ports. FIG. 8 schematically illustrates another explanatory fiber distribution terminal 502B having a multifiber input port 506B and eight multifiber output ports fiber arranged in two rows. Fiber distribution terminal 502B has a multifiber input port 506B having four optical fibers (4F MF) presented at the multifiber input port as shown in FIG. 8. Three of the four input fibers from the multifiber input port 506B each are optically coupled as an input to one of three respective 1×32 splitters, which yields 96 distribution optical fibers amongst the eight 12-fiber multifiber output ports (12F OP). The fourth input fiber of fiber input port 506B is routed as a pass-through fiber from the input port 506B to a single fiber pass-through (1F PT) output port 510.

FIG. 9 depicts the partial wiring scheme 515B of the 96 distribution optical fibers from the three 1×32 splitters 512 to eight 12-fiber output ports of fiber distribution terminal 502B. As depicted, the first 1×32 splitter (splitter 1) routes optical fibers 1-12 to multifiber port 1 and populates the entirety of the first 12-fiber output port. Likewise, the first 1×32splitter (splitter 1) routes optical fibers 13-24 to multifiber port 2 and populates the entirety of the second first 12-fiber output port. Splitter 1 also feeds the remaining distribution optical fibers 25-32 to port 3 and partially populates eight channels of the third 12-fiber output port. Splitter 2 feeds distribution optical fibers 33-36 to port 3 for populating the remaining 14 channels of the third 12-fiber output port as shown. Splitter 2 also feeds distribution optical fibers 37-48 to port 4 for populating the 12 channels of the fourth 12-fiber output port as shown. Splitter 2 further feeds distribution optical fibers 49-60 to port 5 for populating the 12 channels of the fifth 12-fiber output port as shown. Splitter 2 also feeds the remaining distribution optical fibers 61-64 to port 6 and partially populates four channels of the sixth 12-fiber output port. Splitter 3 feeds the distribution optical fibers 65-72 to port 6 for populating the remaining eight channels of the sixth 12-fiber output port. Splitter 3 also feeds the distribution optical fibers 73-84 to port 7 and populates the twelve channels of the seventh 12-fiber output port. Splitter 3 also further feeds the distribution optical fibers 85-96 to port 8 and populates the twelve channels of the eight 12-fiber output port. Consequently, two of three 1×32 three splitters route distribution optical fibers to three 12-fiber output ports and the third 1×32s splitter routes distribution optical fibers to four 12-fiber output ports in the fiber distribution terminal 502B.

Other variations of fiber distribution terminals may use multiple 1×16 splitters within the fiber distribution terminal. FIG. 10 schematically illustrates another explanatory fiber distribution terminal 502C having a multifiber input port 506C and two multifiber output ports fiber arranged in two rows. Fiber distribution terminal 502C has a multifiber input port 506C having four optical fibers (4F MF) presented at the multifiber input port as shown in FIG. 10. Three of the four input fibers from the multifiber input port 506C each are optically coupled as an input to one of three respective 1×16 splitters, which yields 48 distribution optical fibers amongst the two 24-fiber multifiber output ports (24F OP). The fourth input fiber of fiber input port 506C is routed as a pass-through fiber from the input port 506C to a single fiber pass-through (1F PT) output port 510.

FIG. 11 depicts the partial wiring scheme 515C of the 48 distribution optical fibers from the three 1×16 splitters to two 24-fiber output ports of fiber distribution terminal 502C. As depicted, the first 1×16 splitter 512 (splitter 1) routes optical fibers 1-16 to multifiber port 1 and populates the first 16-channels of the first 24-fiber output port. Splitter 2 feeds distribution optical fibers 17-24 to port 1 for populating the remaining 8 channels of the first 24-fiber output port as shown. Splitter 2 also feeds distribution optical fibers 25-32 to port 2 for populating the first 8 channels of the second 24-fiber output port as shown. Splitter 3 feeds the distribution optical fibers 33-48 to port 3 and partially populates the last sixteen channels of the second 24-fiber output port. Consequently, the two 24-fiber output ports (ports 1 and 2) of fiber distribution terminal 502C are each fed distribution optical fibers from two respective 1×16 splitters in the fiber distribution terminal 502C.

Other variations of the wiring scheme of the 48 distribution optical fibers from the three 1×16 splitters for fiber distribution terminals are also possible by changing the fiber count of the multifiber output ports. FIG. 12 schematically illustrates another explanatory fiber distribution terminal 502D having a multifiber input port 506D and four multifiber output ports fiber arranged in two rows. Fiber distribution terminal 502D has a multifiber input port 506D having four optical fibers (4F MF) presented at the multifiber input port as shown in FIG. 12. Three of the four input fibers from the multifiber input port 506D each are optically coupled as an input to one of three respective 1×16 splitters, which yields 48 distribution optical fibers amongst the four 12-fiber multifiber output ports (12F OP). The fourth input fiber of fiber input port 506D is routed as a pass-through fiber from the input port 506D to a single fiber pass-through (1F PT) output port 510.

FIG. 13 depicts the partial wiring scheme 515D of the 48 distribution optical fibers from the three 1×16 splitters 512 to four 12-fiber output ports of fiber distribution terminal 502D. As depicted, the first 1×16 splitter (splitter 1) routes optical fibers 1-12 to multifiber port 1 and populates the entirety of the first 12-fiber output port. Likewise, the first 1×16 splitter (splitter 1) routes the remaining optical fibers 13-16 to multifiber port 2 and partially populates four channels of the second 12-fiber output port. Splitter 2 feeds distribution optical fibers 17-24 to port 2 for populating the remaining eight channels of the second 12-fiber output port as shown. Splitter 2 also feeds distribution optical fibers 25-32 to port 3 for populating eight channels of the third 12-fiber output port as shown. Splitter 3 feeds the distribution optical fibers 33-36 to port 3 for populating the remaining four channels of the third 12-fiber output port. Splitter 3 also feeds the distribution optical fibers 37-48 to port 4. Consequently, the two 12-fiber output ports (ports 2 and 3) of fiber distribution terminal 502D are each fed distribution optical fibers from two respective 1×16 splitters in the fiber distribution terminal 502D.

Other variations of the fiber distribution terminals are also possible. For instance, the wiring schemes may be duplicated within the fiber distribution terminal by adding another input port with a similar wiring scheme as the first input port for feeding further multifiber output ports in a similar fashion. Additionally, the multifiber input ports may support more than 4 input fibers such as six input fibers, eight input fibers or 12 input fibers with similar wiring schemes as shown from the splitters and supporting more pass-through fibers such as a multiple single fiber pass-through ports, a multi-fiber pass-through port or combination thereof as desired such as one single-fiber pass-through port and one multifiber pass-through port. Consequently, the input ports and output ports for the fiber distribution terminals may be configured accordingly as desired for the deployment of the specific neighborhood or location.

According to the concepts disclosed fiber distribution terminals may also be pre-wired for quick and easy testing capability by the user in the field using a test jumper cable across ports. Testing of the fiber distribution terminal 602 is accomplished by including a separate set of testing ports configured for testing the ports carrying optical traffic. The fiber distribution terminal may include testing ports that may be used in various manners as desired. The fiber distribution terminals having testing ports use a multifiber test input port 608 along with a plurality of single fiber test input ports 612 for allowing the user to test the internal connections of the fiber distribution terminals.

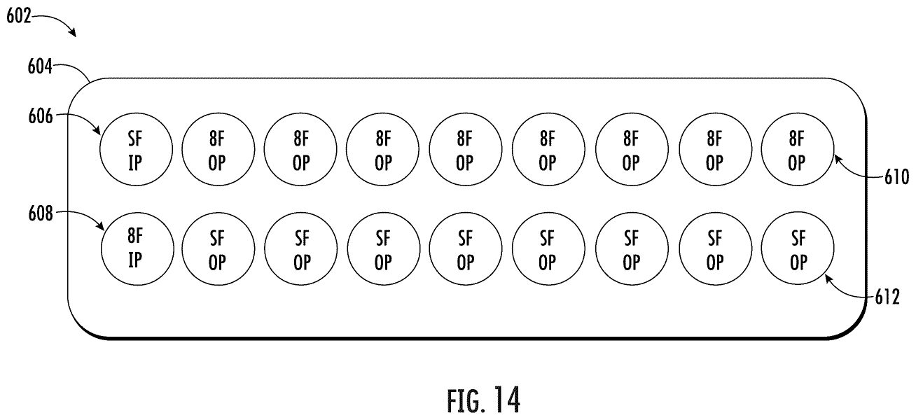

By way of explanation, FIG. 14 illustrates an embodiment wherein the fiber distribution terminal 602 has built-in testing capabilities for evaluating individual single fibers. The example fiber distribution terminal 602 includes a single fiber input port 606, a plurality of multifiber output ports 610, a multifiber test input port 608, and a plurality of single fiber test input ports 612. The single fiber input port 606 is operable to receive a single fiber connector. For regular use for optical communication, the plurality of single fiber test input ports 612 is used for testing as described herein. However, this fiber distribution terminal 602 also additionally provides the capability for testing continuity through the terminal and splitters for the individual optical channels.

The testing ports of the fiber optic distribution terminal may unplug an installed multifiber connector from the desired multifiber output ports 610 and plug into the multifiber test input port 608.

Alternatively, the user may use a multifiber test jumper cable that is plugged into a desired multifiber output ports 610 being tested and the multifiber test input port 608 to optically connect the desired ports. To test an individual multifiber output port 610, a test optical cable having multifiber connectors on each end is coupled to the multifiber test input port 608 at one end and the desired multifiber output ports 610 at the other end.

Consequently, the multifiber test input port 608 is optically coupled to the plurality of single fiber test input ports 612 by a plurality of internal optical fiber jumpers of the fiber distribution terminal 602. In this manner, each channel of the multifiber test input port 608 is optically coupled to an individual single fiber test input port 612. When there is an issue or testing is desired with one or more channels of a multifiber output port 610, the multifiber output port 610 may be optically coupled to the multifiber test input port 608 by the test optical cable. Then, each individual single fiber test input port 612 can be evaluated to determine if channel has continuity or not for troubleshooting or verification as desired. Thus, the individual single fiber test input port 612 may be used as an input for a test set to verify if a particular channel is operational or not. Corrective action may then be taken if there is an issue with any of the channels. When the problem is resolved, the test optical cable can be removed and the associated multifiber leg of an optical cable assembly may be reinstalled for normal use.

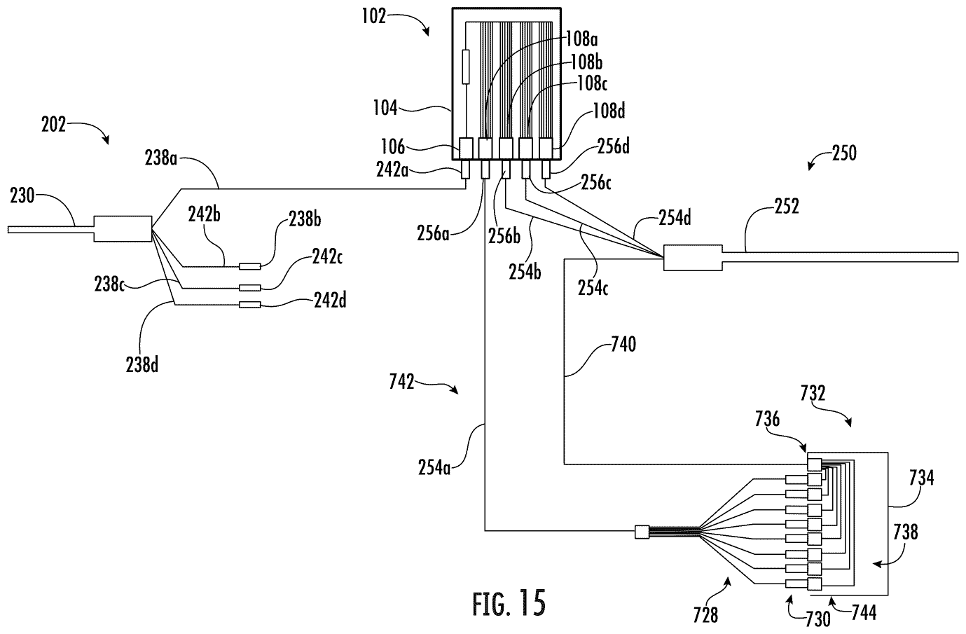

Instead of being incorporated into the module. Referring now to FIG. 15, an optical system comprising a testing module 732 is illustrated. The optical system also includes a fiber distribution terminal 102, an input optical cable assembly 202, and an output optical cable assembly 250 as described above with respect to FIG. 2. The testing module 732 allows a user to test individual multifiber output ports without interrupting service to subscribers on the other multifiber output ports as well as individual channels of the multifiber output port being evaluated.

The testing module 732 comprises a test housing 734 that defines an enclosure that maintains a plurality of fiber jumpers 738. As illustrated, the front face of the test housing 734 includes at least one test multifiber port 736 and a plurality of test single fiber ports 744, but the ports may have any suitable location on testing module 732. The plurality of fiber jumpers 738 is optically coupled to the test multifiber port 736 at one end and the plurality of test single fiber ports 744 at the other end such that an individual channel of the test multifiber port 736 is optically coupled to an individual test single fiber port 744.

The testing module 732 may be used by plugging in between the multifiber optical cable 252 and the fiber distribution terminal 102 for testing of the optical network. The testing module 732 may be used with a test optical cable assembly 742 while still allowing live traffic on the optical network to the extent possible. To test the optical network, a multifiber leg 740 of the multifiber optical cable 252 terminated with multifiber connector 732 is routed to the input port of the testing module 732. The plurality of optical fibers terminated by multifiber connector 732 is broken out into individual optical channels using single fiber outport ports the testing module 732. Consequently, test optical cable assembly 742 comprises a plurality of test single fiber connectors 730 disposed on respective single fiber legs 728 at a first end and a second end of the test optical cable assembly 742 comprises a multifiber connector terminated on multifiber leg 254a for optical connection to the desired multifiber port of fiber distribution terminal 102. Therefore, individual channels of the multifiber connector 736 are optically coupled to an individual test single fiber connector 730 at the testing module 732 and continuity of the individual optical channels of the multifiber optical cable 252 and multifiber output port 108a of fiber distribution terminal 102 may be tested.

Specifically, FIG. 15 illustrates the testing of multifiber output port 108a of the distribution fiber terminal 102. The multifiber connector 732 of multifiber leg 740 of the output optical cable assembly 250 is removed from multifiber output port 108a and then connected to the test multifiber port 736 of the testing module 732. The multifiber connector of the test optical cable assembly 742 terminated on multifiber leg 254a is then connected to multifiber output port 108a as the new multifiber connector 256a, which is the output port of fiber distribution terminal 102 being tested. Likewise, the other multifiber ports 108b-108d may be tested in a similar manner.

The test single fiber connectors 730 are connected to the test single fiber ports 744 of the testing module 732 as desired to test the optical network. The fiber jumpers 738 optically couple the test single fiber connectors 730 to the test multifiber port 736. Therefore, optical communication may continue to subscribers through the testing module 732 with less interruption of live traffic. When an individual channel is to be tested, the corresponding test single fiber port 744 is disconnected from the testing module 732 and then connected to an evaluation device (not shown) for testing. Advantageously, all other channels may remain active while testing is performed on the one channel under test.

It should now be understood that embodiments of the present disclosure are directed to compact, high-density fiber distribution terminals with equivalent number of output fiber connections within hardened components that can be installed via pole or wall mount, on the back of a development entry sign, attached to aerial strand or in a hand hole in the ground. The fiber distribution terminals disclosed herein allow rapid deployment through elimination of splice points throughout the neighborhood with the ability to add additional fiber distribution terminals to the system as the area grows with more subscribers. Embodiments also optimize the deployment of small segments of homes where a traditional LCP cabinet might be too large or expensive. Additionally, embodiments provide for the ability to test individual channels of a multifiber connection either by providing breakouts within the fiber distribution terminal itself or by use of a testing module.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application covers the modifications and variations provided they come within the scope of the appended claims and their equivalents.

1. A fiber distribution terminal comprising:
a housing having a body, the housing defining an enclosure;
a splitter comprising an input and a plurality of outputs;
an input port on the housing;
a plurality of multifiber output ports on the body of the housing;
a single fiber optically coupled to the input port and the input of the splitter; and
a plurality of multifiber output legs, each multifiber output leg coupled to an individual output of the plurality of outputs of the splitter and to an individual multifiber output port of the plurality of multifiber output ports.

2. The fiber distribution terminal of claim 1, wherein the splitter is a PLC splitter.

3. The fiber distribution terminal of claim 1, further comprising:
a pass-through input port;
a pass-through output port; and
a pass-through fiber optically coupled to the pass-through input port and the pass-through output port.

4. The fiber distribution terminal of claim 1, further comprising:
at least one additional input port;
at least one additional splitter comprising an input and a plurality of outputs; and
at least one additional single fiber optically coupled to the input of the at least one additional splitter, wherein some multifiber output legs of the plurality of multifiber output legs are optically coupled to the plurality of outputs of the at least one additional splitter and some multifiber output ports of the plurality of multifiber output ports.

5. The fiber distribution terminal of claim 1, further comprising a plurality of single fiber output ports.

6. The fiber distribution terminal of claim 1, wherein each optical fiber of one multifiber output leg of the plurality of multifiber output legs is optical coupled to an individual single fiber output port of the plurality of single fiber output ports.

7. The fiber distribution terminal of claim 1, wherein each multifiber output port of the plurality of multifiber output ports is coupled to eight optical fibers.

8. An optical communications system comprising:
a fiber distribution terminal comprising:
a housing having a body, the housing defining an enclosure;
a splitter comprising an input and a plurality of outputs;
an input port on the body of the housing;
a plurality of multifiber output ports on the body of the housing;
a single fiber optically coupled to the input port and the input of the splitter; and
a plurality of multifiber output legs, each multifiber output leg coupled to an individual output of the plurality of outputs of the splitter and to an individual multifiber output port of the plurality of multifiber output ports;
an input optical cable assembly comprising a single optical fiber and a single fiber connector, wherein the single fiber connector is operable to be coupled to the input port of the terminal; and
an output optical cable assembly comprising a plurality of multifiber legs, each multifiber leg being coupled to a multifiber connector operable to be coupled to an individual multifiber output port of the plurality of multifiber output ports.

9. The optical communications system of claim 8, wherein the splitter is a PLC splitter.

10. The optical communications system of claim 8, wherein the fiber distribution terminal further comprises:
a pass-through input port;
a pass-through output port; and
a pass-through fiber optically coupled to the pass-through input port and the pass-through output port.

11. The optical communications system of claim 10, further comprising a first pass-through optical cable assembly optically coupled to the pass-through input port and a second pass-through optical cable assembly optically coupled to the pass-through output port.

12. The optical communications system of claim 8, wherein the fiber distribution terminal further comprises:
at least one additional input port;
at least one additional splitter comprising an input and a plurality of outputs; and
at least one additional single fiber optically coupled to the input of the at least one additional splitter, wherein some multifiber output legs of the plurality of multifiber output legs are optically coupled to the plurality of outputs of the at least one additional splitter and some multifiber output ports of the plurality of multifiber output ports.

13. The optical communications system of claim 8, wherein the fiber distribution terminal further comprises a plurality of single fiber output ports.

14. The optical communications system of claim 8, wherein each optical fiber of one multifiber output leg of the plurality of multifiber output legs is optically coupled to an individual single fiber output port of the plurality of single fiber output ports.

15. The optical communications system of claim 8, wherein each multifiber output port of the plurality of multifiber output ports is coupled to eight optical fibers.

16. A fiber distribution terminal comprising:
a housing having a body, the housing defining an enclosure;
a plurality of splitters each of the plurality of splitters comprising an input and a plurality of outputs, wherein the plurality of splitters comprise a predetermined split ratio for the plurality of outputs;
a multifiber input port on the housing having a plurality of input fibers;
a plurality of multifiber output ports on the body of the housing, wherein the plurality of multifiber outport ports comprise a predetermined fiber count and the predetermined fiber count of the multifiber output ports is different than the predetermined split ratio of the plurality of splitters;
a plurality of input fibers each being optically coupled to the multifiber input port and the input of one of the plurality of splitters; and
a plurality of multifiber output legs, each multifiber output leg coupled to an individual output of the plurality of outputs of one of the plurality of splitters and optically coupled to one of the plurality of the multifiber output ports.

17. The fiber distribution terminal of claim 16, wherein the splitter is a PLC splitter.

18. The fiber distribution terminal of claim 16, further comprising:
one of the plurality of input fibers being a pass-through optical fiber;
a pass-through output port; and
the pass-through optical fiber optically coupled to the pass-through output port.

19. The fiber distribution terminal of claim 16, wherein the plurality of splitters comprise three splitters each having the predetermined split ratio of 1×32 and the plurality of multifiber output ports comprise four multifiber outport ports each having the predetermined fiber count of 24-fibers.

20. The fiber distribution terminal of claim 16, wherein the plurality of splitters comprise three splitters each having the predetermined split ratio of 1×32 and the plurality of multifiber output ports comprise eight multifiber outport ports each having the predetermined fiber count of 12-fibers.

21. The fiber distribution terminal of claim 16, wherein the plurality of splitters comprise three splitters each having the predetermined split ratio of 1×16 and the plurality of multifiber output ports comprise two multifiber outport ports each having the predetermined fiber count of 24-fibers.

22. The fiber distribution terminal of claim 16, wherein the plurality of splitters comprise three splitters each having the predetermined split ratio of 1×16 and the plurality of multifiber output ports comprise four multifiber outport ports each having the predetermined fiber count of 12-fibers.

23. The fiber distribution terminal of claim 16, further comprising at least one multifiber pass-through output port.

24. The fiber distribution terminal of claim 16, wherein the plurality of splitters comprises X-number of splitters and the plurality of multifiber output ports comprises Y-number of multifiber output ports, and the X-number of splitters is different than the Y-number of multifiber output ports.

25. The fiber distribution terminal of claim 24, wherein the X-number of splitters is greater than the Y-number of multifiber output ports.

26. The fiber distribution terminal of claim 24, wherein the X-number of splitters is less than the Y-number of multifiber output ports.

27. An optical system comprising:
a fiber distribution terminal comprising:
a housing having a body, the housing defining an enclosure;
a splitter comprising an input and a plurality of outputs;
an input port on the body of the housing;
a plurality of multifiber output ports on the body of the housing;
a single fiber optically coupled to the input port and the input of the splitter; and
a plurality of multifiber output legs, each multifiber output leg coupled to an individual output of the plurality of outputs of the splitter and to an individual multifiber output port of the plurality of multifiber output ports; and
a test optical cable assembly comprising a multifiber optical cable comprising a plurality of optical fibers coupled to a multifiber connector at a first end and a plurality of single fiber connectors coupled to a second end of the plurality of optical fibers; and
a testing module comprising:
a test housing defining a test enclosure;
a plurality of test single fiber ports at a surface of the test housing operable to receive the plurality of single fiber connectors;
a test multifiber port for receiving a multifiber leg of an optical cable assembly; and
a plurality of fiber jumpers, wherein each fiber jumper is optically coupled to the test multifiber port at a first end and an individual test single fiber port of the plurality of test single fiber ports at a second end.

28. The optical system of claim 27, wherein the splitter is a PLC splitter.

29. The optical system of claim 27, wherein the fiber distribution terminal further comprises:
a pass-through input port;
a pass-through output port; and
a pass-through fiber optically coupled to the pass-through input port and the pass-through output port.

30. The optical system of claim 27, further comprising a first pass-through optical cable assembly optically coupled to the pass-through input port and a second pass-through optical cable assembly optically coupled to the pass-through output port.

31. The optical system of claim 27, wherein the fiber distribution terminal further comprises:
at least one additional input port;
at least one additional splitter comprising an input and a plurality of outputs; and
at least one additional single fiber optically coupled to the input of the at least one additional splitter, wherein some multifiber output legs of the plurality of multifiber output legs are optically coupled to the plurality of outputs of the at least one additional splitter and some multifiber output ports of the plurality of multifiber output ports.

32. The optical system of claim 27, wherein the fiber distribution terminal further comprises a plurality of single fiber output ports.

33. The optical system of claim 27, wherein each optical fiber of one multifiber output leg of the plurality of multifiber output legs is optically coupled to an individual single fiber output port of the plurality of single fiber output ports.

34. The optical system of claim 27, wherein each multifiber output port of the plurality of multifiber output ports is coupled to eight optical fibers.

35. A method of testing an optical communication system, the method comprising:
disconnecting a multifiber leg of an optical cable assembly from a multifiber output port of a fiber distribution terminal, the fiber distribution terminal further comprising:
a housing having a body, the housing defining an enclosure;
a splitter comprising an input and a plurality of outputs;
an input port on the body of the housing;
a plurality of multifiber output ports on the body of the housing, wherein the multifiber output port is an individual one of the plurality of multifiber output ports;
a single fiber optically coupled to the input port and the input of the splitter; and
a plurality of multifiber output legs, each multifiber output leg coupled to an individual output of the plurality of outputs of the splitter and to an individual multifiber output port of the plurality of multifiber output ports; and
connecting the multifiber leg of the optical cable assembly to a test multifiber port of a testing module, the testing module further comprising:
a test housing defining a test enclosure;
a plurality of test single fiber ports at a surface of the test housing;
the test multifiber port; and
a plurality of fiber jumpers, wherein each fiber jumper is optically coupled to the test multifiber port at a first end and an individual test single fiber port of the plurality of test single fiber ports at a second end;
connecting a multifiber connector of a test optical cable assembly to the multifiber output port of the plurality of multifiber output ports and connecting a plurality of single fiber connectors to the plurality of test single fiber ports; and
testing an optical signal propagating within one or more individual single fiber connectors by removing the one or more individual single fiber connectors from the plurality of test single fiber ports.

36. The method of claim 35, wherein the one or more individual single fiber connectors are removed from the plurality of test single fiber ports one at a time.

37. The method of claim 35, wherein the splitter is a PLC splitter.

38. The method of claim 35, wherein the fiber distribution terminal further comprises:
a pass-through input port;
a pass-through output port; and
a pass-through fiber optically coupled to the pass-through input port and the pass-through output port.

39. The method of claim 35, further comprising a first pass-through optical cable assembly optically coupled to the pass-through input port and a second pass-through optical cable assembly optically coupled to the pass-through output port.

40. The method of claim 35, wherein the fiber distribution terminal further comprises:
at least one additional input port;
at least one additional splitter comprising an input and a plurality of outputs; and
at least one additional single fiber optically coupled to the input of the at least one additional splitter, wherein some multifiber output legs of the plurality of multifiber output legs are optically coupled to the plurality of outputs of the at least one additional splitter and some multifiber output ports of the plurality of multifiber output ports.

41. The method of claim 35, wherein the fiber distribution terminal further comprises a plurality of single fiber output ports.

42. The method of claim 35, wherein each optical fiber of one multifiber output leg of the plurality of multifiber output legs is optically coupled to an individual single fiber output port of the plurality of single fiber output ports.

43. The method of claim 35, wherein each multifiber output port of the plurality of multifiber output ports is coupled to eight optical fibers.
